(19) United States
(12) Patent Application Publication
(10) Pub. No.: US 2025/0365528 A1
(43) Pub. Date: Nov. 27, 2025

(54) APPARATUS AND METHOD FOR PREVENTING LOSS OF WIRELESS ACOUSTIC EQUIPMENT

(71) Applicant: LG ELECTRONICS INC., Seoul (KR)

(72) Inventors: Jaeshin LEE, Seoul (KR); Byoungchang CHO, Seoul (KR); Hyojin KIM, Seoul (KR); Yehan AHN, Seoul (KR); Mansoo SIN, Seoul (KR)

(73) Assignee: LG ELECTRONICS INC., Seoul (KR)

(21) Appl. No.: 18/872,587

(22) PCT Filed: Jun. 7, 2022
(86) PCT No.: PCT/KR2022/008030

§ 371 Date: Dec. 6, 2024

(51) Int. Cl. H04R 1/10; G01C 21/16; G01P 15/00; G08B 3/10; G08B 21/18

(52) U.S. Cl. CPC H04R 1/1091; G01C 21/16; G01P 15/00; G08B 3/10; G08B 21/182; H04R 2430/01

(57) ABSTRACT

The present disclosure relates to an apparatus and method for preventing loss of wireless sound device capable of recognizing a fall and preventing loss, the apparatus including: a sensing part sensing the fall of a wireless sound device; a communication part communicating with at least one device; a loss notification part outputting a loss notification of the wireless sound device; and a control part controlling the communication part and the loss notification part, in which the control part can calculate the falling distance of the wireless sound device from the sensing signal of the sensing part, determine whether the wireless sound device is lost based on the calculated falling distance, if the wireless sound device is lost, control the loss notification part to output the loss notification, and if movement of the wireless sound device is recognized from the sensing signal of the sensing part after the output of the loss notification, control the loss notification part to stop outputting the loss notification.

### TECHNICAL FIELD

The present disclosure relates to an apparatus and method for preventing loss of wireless sound device capable of recognizing a fall and preventing loss.

### BACKGROUND ART

A wireless sound device means a device that receives sound signals from a terminal via wireless communication and outputs sound corresponding to the received sound signals.

With the recent development of wireless communication technology, the demand and supply of wireless sound devices are increasing significantly due to their greater portability and convenience compared to wired sound devices.

Personalized devices such as these wireless sound devices are gradually becoming smaller for convenience of wearing.

However, as wireless sound devices become smaller for convenience of wearing, the risk of losing them increases.

In particular, if the user does not recognize that the wireless sound device has been lost and moves a long distance from the place where it was lost, it is nearly impossible to find the lost wireless sound device.

Therefore, there is a need for the development of an apparatus for preventing loss that can recognize the fall of a wireless sound device and prevent loss thereof.

### DISCLOSURE

### Technical Problem

An object of the present disclosure is to solve the problems described above and other problems.

An object of the present disclosure is to provide an apparatus for preventing loss of wireless sound device capable of preventing the loss of a wireless sound device by recognizing the falling of the wireless sound device and notifying the user of the loss of the wireless sound device.

In addition, an object of the present disclosure is to provide an apparatus for preventing loss of wireless sound device, which can improve the usability of the wireless sound device for the user by minimizing loss situations with minimal power consumption, by providing a variety of loss alerts on its own and adjusting the loss alerts according to the surrounding environment by the wireless audio device.

### Technical Solution

According to one embodiment of the present disclosure, an apparatus for preventing loss of wireless sound device includes a sensing part sensing the fall of a wireless sound device; a communication part communicating with at least one device; a loss notification part outputting a loss notification of the wireless sound device; and a control part controlling the communication part and the loss notification part, in which the control part may calculate the falling distance of the wireless sound device from the sensing signal of the sensing part, determine whether the wireless sound device is lost based on the calculated falling distance, if the wireless sound device is lost, control the loss notification part to output the loss notification, and if movement of the wireless sound device is recognized from the sensing signal of the sensing part after the output of the loss notification, control the loss notification part to stop outputting the loss notification.

According to one embodiment of the present disclosure, a method for preventing loss of a wireless sound device may include sensing the falling of the wireless sound device; calculating the falling distance of the wireless sound device; determining whether the wireless sound device is lost based on the calculated falling distance; outputting a loss notification if the wireless sound device is lost; recognizing the movement of the wireless sound device; and stopping output of the loss notification if movement of the wireless sound device is recognized.

### Advantageous Effect

According to one embodiment of the present disclosure, an apparatus for preventing loss of wireless sound device can prevent loss of a wireless sound device by recognizing a fall of the wireless sound device and notifying a user of the loss of the wireless sound device.

In addition, according to one embodiment of the present disclosure, the apparatus for preventing loss of the wireless sound device can improve the usability of the wireless sound device for the user by minimizing loss situations with minimal power consumption, by providing a variety of loss alerts on its own and adjusting the loss alerts according to the surrounding environment by the wireless audio device.

### DESCRIPTION OF DRAWINGS

FIG. 1 is a diagram illustrating a system for preventing loss of wireless sound device according to one embodiment of the present disclosure.

FIG. 2 is a perspective view illustrating a wireless sound device according to an embodiment of the present disclosure.

FIG. 3 is a block diagram illustrating a wireless sound device according to an embodiment of the present disclosure.

FIG. 4 is a view illustrating a method for calculating a falling distance of a wireless sound device according to one embodiment of the present disclosure.

FIGS. 5 to 7 are views illustrating a method for predicting a collision environment of a wireless sound device according to an embodiment of the present disclosure.

FIG. 8 is a view illustrating a method for determining loss of a wireless sound device according to an embodiment of the present disclosure.

FIGS. 9 to 11 are views illustrating a method for notifying loss of a wireless sound device according to an embodiment of the present disclosure.

FIGS. 12 and 13 are views illustrating a method for transmitting information on loss situation of a wireless sound device to a peripheral device according to an embodiment of the present disclosure.

FIGS. 14 to 17 are flowcharts illustrating a method for preventing loss of a wireless sound device according to an embodiment of the present disclosure.

### BEST MODE

Hereinafter, embodiments disclosed in this specification will be described in detail with reference to the attached drawings, wherein, regardless of the drawing symbols, identical or similar components will be given the same reference numerals and redundant descriptions thereof will be omitted. The suffixes “module” and “part” used for components in the following description are assigned or used interchangeably only for the convenience of writing the specification, and do not have distinct meanings or roles in themselves. In addition, when describing embodiments disclosed in this specification, if it is determined that a specific description of a related known technology may obscure the gist of the embodiments disclosed in this specification, the detailed description thereof will be omitted. In addition, the attached drawings are only intended to facilitate easy understanding of the embodiments disclosed in this specification, and the technical ideas disclosed in this specification are not limited by the attached drawings, and should be understood to include all modifications, equivalents, and substitutes included in the idea and technical scope of the present disclosure.

Terms including ordinal numbers, such as first, second, and the like may be used to describe various components, but the components are not limited by the terms. The terms are used only to distinguish one component from another.

When it is said that a component is “connected” or “accessed” to another component, it should be understood that it may be directly connected or accessed to that other component, but that there may be other components in between. On the other hand, when it is said that a component is “directly connected” or “directly accessed” to another component, it should be understood that there are no other components in between.

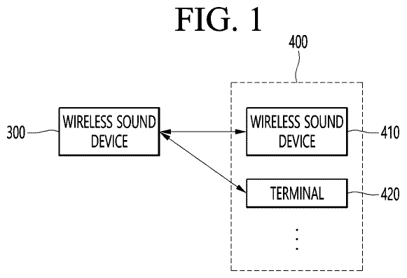

FIG. 1 is a diagram illustrating a system for preventing loss of wireless sound device according to one embodiment of the present disclosure.

As illustrated in FIG. 1, an apparatus for preventing loss of wireless sound device may include a wireless sound device 300 and a device 400 that communicates with the wireless sound device 300.

Here, the device 400 may include another wireless sound device 410 that perform communication with the wireless sound device 300, a terminal 420, or the like.

For example, wireless sound devices 300, 410 may include headphones, neckband-type earphones, canal-type earphones, open-type earphones, bone conduction earphones, or the like.

In addition, the terminal 420 may include a fixed device or a movable device, such as a TV, a projector, a mobile phone, a smart phone, a desktop computer, a laptop, a digital broadcasting terminal, a PDA (personal digital assistant), a PMP (portable multimedia player), a navigation device, a tablet PC, a wearable device, a set-top box (STB), a DMB receiver, a radio, a washing machine, a refrigerator, a digital signage, a robot, a vehicle, or the like.

The wireless sound device 300 can calculate the falling distance of the wireless sound device 300 through a built-in sensor, determine whether the wireless sound device 300 is lost based on the calculated falling distance, and output a loss notification if the wireless sound device 300 is lost.

In addition, the wireless sound device 300 can transmit information about the loss situation of the wireless sound device 300 to at least one of another wireless sound device 410 and a terminal 420 worn or owned by the user, thereby allowing the user to recognize the loss situation of the wireless sound device 300.

In addition, when the loss situation of the wireless sound device 300 ends, the wireless sound device 300 may transmit information on end of the loss situation to at least one of another wireless sound device 410 and a terminal 420 worn or owned by the user, thereby allowing the user to recognize the end of the loss situation of the wireless sound device 300.

In addition, when the wireless sound device 300 receives loss situation information from a device 400 including another wireless sound device 410 and a terminal 420 which are communicated with the wireless sound device, the wireless sound device 300 outputs a loss alarm corresponding to the device 400, thereby allowing the user to be aware of the loss situation of another wireless sound device 410 and terminal 420 owned by the user.

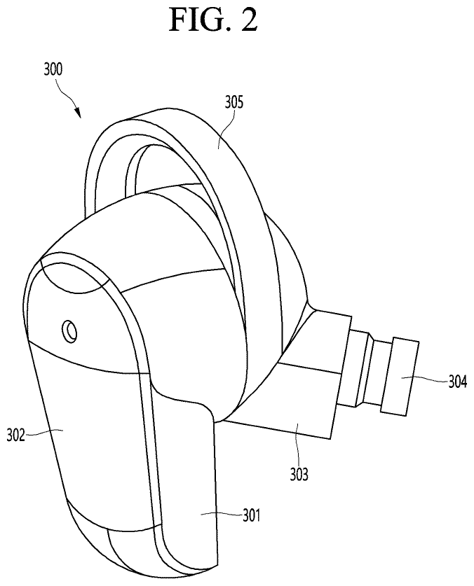

FIG. 2 is a perspective view illustrating a wireless sound device according to an embodiment of the present disclosure.

The wireless sound device 300 illustrated in FIG. 2 is a kernel-type wireless earphone, which is only an example, and the present disclosure is not limited thereto.

In other words, the wireless sound device 300 in the present disclosure may include headphones, neckband-type earphones, canal-type earphones, open-type earphones, bone conduction earphones, or the like.

As illustrated in FIG. 2, the wireless sound device 300 includes a plurality of cases 301, 302, 303, 305, and the cases 301, 302, 303, 305 can be coupled to form a housing including an internal space in which electronic components are mounted.

A second case 302 coupled to one side of the first case 301 is a part exposed to the outside when the user wears the wireless sound device 300, and an sound output part 340 that outputs sound according to an sound signal is positioned on the other side of the first case 301 so that an sound passage 304 that transmits sound to the user can be provided.

To facilitate mounting of components (for example,, sound output part 340, communication part 385) in the first case 301, the part where the sound passage 304 is located can be separated to form a separate case 303.

The wireless sound device 300 has an sound passage 304 that protrudes in a form that can be inserted into the user's external auditory canal in a canal-type form, and an ear tip can be coupled to the outside of the sound passage 304 so as to fit snugly against the user's ear.

In addition, the wireless sound device 300 may be equipped with a sensor that senses the falling of the wireless sound device 300 and an output device that outputs a loss notification of the wireless sound device 300.

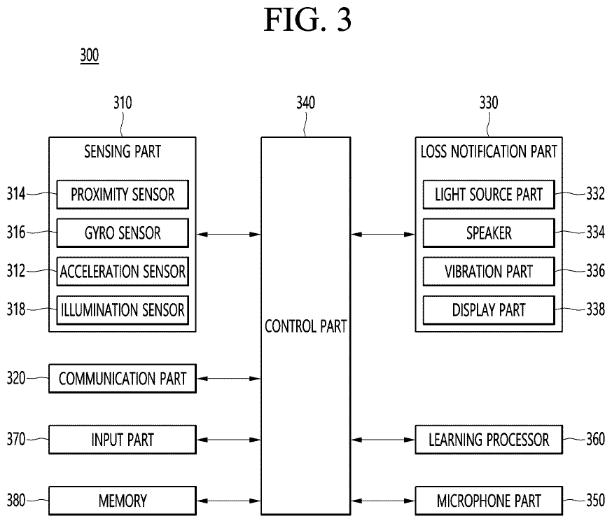

FIG. 3 is a block diagram illustrating a wireless sound device according to an embodiment of the present disclosure.

As illustrated in FIG. 3, the wireless sound device 300 may include a sensing part 310, a communication part 320, a loss notification part 330, a control part 340, a microphone part 350, a running processor 360, an input part 370, a memory 380, or the like.

For example, the sensing part 310 may include an acceleration sensor 312 that senses changes in acceleration due to gravity.

Here, the acceleration sensor 312 can sense the falling of the wireless sound device 300, and the present disclosure can determine the loss of the wireless sound device 300 based on the sensing signal of the acceleration sensor 312.

Additionally, the sensing part 310 may further include at least one of a proximity sensor 314 and a gyro sensor 316.

Here, the proximity sensor 314 can sense the user's wearing status of the wireless sound device 300, and the gyro sensor 316 can sense the falling direction of the wireless sound device 300.

Additionally, the sensing part 310 may further include an illumination sensor 318.

Here, the illumination sensor 318 can sense the surrounding brightness, and the present disclosure can determine whether the loss of the wireless sound device 300 is outdoors or indoors based on the sensing signal of the illumination sensor 318, and can minimize power usage by adjusting the intensity of the loss notification light.

Next, the communication part 320 can communicate with at least one device.

Here, the device may include other wireless sound devices and terminals, or the like.

The communication part 320 can transmit and receive data with external devices such as other wireless sound devices and terminals using wireless communication technology, and can include an antenna for transmitting and receiving wireless signals.

Next, the lost notification part 330 can output a lost notification of the wireless sound device 300.

Here, the loss notification part 330 may include at least one of a light source part 332 that outputs a loss notification of the wireless sound device 300 as light, a speaker 334 that outputs a loss notification of the wireless sound device 300 as sound, a vibration part 336 that outputs a loss notification of the wireless sound device 300 as vibration, and a display part 338 that displays a loss notification of the wireless sound device 300 as a message.

For example, the light source part 332 may include at least one light-emitting diode, but this is only an example and is not limited thereto.

In addition, the microphone part 350 can receive ambient noise, and the present disclosure can adjust the output intensity of the loss notification sound based on the noise level received by the microphone part 350.

Next, the learning processor 360 can train a model composed of an artificial neural network using learning data.

Here, the learned artificial neural network can be referred to as a learning model, and the learning model can be used to infer result values for new input data that is not learning data, and the inferred values can be used as a basis for determination to perform a certain action.

The present disclosure can also estimate the lost location of a wireless sound device by predicting the collision environment of the wireless sound device using a running processor 360.

In other words, the present disclosure can predict the collision environment of a wireless sound device by inputting an acceleration change rate corresponding to a collision time into a pre-learned neural network model, and output collision environment information.

Here, the neural network model can be pre-learned with the acceleration change rate corresponding to the collision time as input.

Next, the input part 370 may mean an input part or input interface for a user to control the wireless sound device 300.

The small-sized wireless sound device 300 can be expanded into control commands that can be input by using a touch format or a limited number of buttons and combining the time and number of button presses and a plurality of buttons.

In addition, the memory 380 can store setting information for determining a loss situation, basic information for providing a loss notification, or the like.

Next, the control part 340 can control the overall operation of the wireless sound device 300.

Here, the control part 340 calculates the falling distance of the wireless sound device 300 from the sensing signal of the sensing part 310, determines whether the wireless sound device 300 is lost based on the calculated falling distance, controls the loss notification part 330 to output a loss notification if the wireless sound device 300 is lost, and controls the loss notification part 330 to stop outputting the loss notification if movement of the wireless sound device 300 is recognized from the sensing signal of the sensing part 310 after the loss notification is output.

In addition, when calculating the falling distance, the control part 340 can identify a free fall region from the sensing signal when a sensing signal is received from the sensing part 310, obtain a free fall time corresponding to the identified free fall region, and calculate the falling distance of the wireless sound device 300 based on the obtained free fall time.

Here, the control part 340 can identify the free fall region based on the acceleration change rate over time in the sensing signal when identifying the free fall region.

In other words, the control part 340 can identify an impact region in which the acceleration value varies at a specific rate of change based on the acceleration change rate, identify a static region in which the acceleration value is constant among the regions prior to the identified impact region, and identify a free fall region in which the acceleration value remains a specific value or less between the identified static region and the impact region.

For example, when identifying a free fall region, the control part 340 can check whether there is a region that maintains an acceleration value of about 0.5 or less for a certain period of time between the static region and the collision region, and if there is a region that maintains an acceleration value of about 0.5 or less for a certain period of time, identify the region as a free fall region.

In addition, when identifying a collision region, the control part 340 can recognize a specific point in time as the start point of the collision region if the acceleration value changes at a specific rate of change that is preset at a specific point in time.

For example, the control part 340 can recognize a specific point in time as the start point of a collision in a collision region if the acceleration value changes from a value of about 0.5 or less to a value of about 1.5 or more at a specific point in time.

In addition, when identifying a collision region, the control part 340 can predict the collision environment of the wireless sound device 300 based on the collision time from the collision start point of the collision region to the collision end point where the acceleration value is maintained constant.

For example, the control part 340 may predict that the collision environment of the wireless sound device is a soft ground if the collision time is within a first hour, predict that the collision environment of the wireless sound device is a hard ground if the collision time is within a second hour longer than the first hour, and predict that the collision environment of the wireless sound device is an inclined ground if the collision time is within a third hour longer than the second hour, but, this is only an example and is not limited thereto.

As another example, the control part 340 can predict the collision environment of the wireless sound device by inputting an acceleration change rate corresponding to the collision time into a pre-learned neural network model and output collision environment information.

Here, the neural network model can be pre-learned with the acceleration change rate corresponding to the collision time as an input value.

In addition, the control part 340 can identify a region as a free fall region, when the acceleration change rate changes from a static region in which a constant acceleration value is maintained for a first time period to a collision region in which the acceleration value is variable for a second time period, if there is a region between the static region and the collision region in which an acceleration value smaller than the acceleration value of the static region is maintained for a certain time period.

For example, the control part 340 can identify a region as a free fall region if there is a region in which an acceleration value of about 0.5 or less is maintained for a certain period of time between the static region and the collision region.

In addition, when obtaining the free fall time, the control part 340 can obtain the free fall time from the time between the start time and the end time during which the acceleration value of about 0.5 or less is maintained among the identified free fall regions.

In addition, the control part 340 can calculate the falling distance by using a formula consisting of h=½×g×t² (where h is the falling distance, g is the gravitational acceleration of 9.81, and t is the free fall time) when calculating the fall distance.

Next, when determining whether a wireless sound device is lost, if calculating the falling distance, the control part 340 can determine whether the calculated falling distance is a preset standard distance or more, and if the falling distance is the standard distance or more, determine that the wireless sound device is lost.

Here, the control part 340 can set the standard distance based on the height of the user wearing the wireless sound device.

For example, the standard distance can be set based on the user's sitting height.

In addition, when setting the standard distance, the control part 340 checks whether there is a user-set value corresponding to the standard distance, and if there is a user-set value, sets the user-set value as the standard distance, and if there is no user-set value, sets the default value set based on the average height of the user wearing the wireless sound device as the standard distance.

Next, if the control part 340 determines that the wireless sound device is lost, the control part 340 can calculate the noise level from the surrounding noise received by the microphone part 350 and control the loss notification part 330 to output a loss notification sound based on the noise level.

Here, the control part 340 can control the loss notification part 330 to output the loss notification sound at an outdoor volume level if the noise level is an outdoor noise level, and can control the loss notification part 330 to output the loss notification sound at an indoor volume level that is lower than the outdoor volume level if the noise level is an indoor noise level.

For example, the control part 340 can control the loss notification part 330 to output a loss notification sound at an outdoor volume level and at the same time output a loss notification light at a preset light intensity when the noise level is an outdoor noise level.

As another example, the control part 340 may control the loss notification part 330 to output a loss notification sound in which the outdoor volume level increases in proportion to the increase rate of the outdoor noise level when the noise level is the outdoor noise level.

As another example, the control part 340 can control the loss notification part 330 to output a loss notification sound at a preset indoor volume level regardless of the rate of increase in the indoor noise level when the noise level is the indoor noise level.

Next, if determining that the wireless sound device is lost, the control part 340 can calculate the ambient brightness level from the sensing signal of the illumination sensor 318 and control the loss notification part 330 to output a loss notification light based on the ambient brightness level.

Here, the control part 340 can control the loss notification part 330 to output the loss notification light with an outdoor light intensity if the ambient brightness level is an outdoor brightness level, and can control the loss notification part 330 to output the loss notification light with an indoor light intensity that is smaller than the outdoor light intensity if the ambient brightness level is an indoor brightness level.

For example, the control part 340 can control the loss notification part 330 to output a loss notification light at the outdoor light intensity and at the same time output a loss notification sound at a preset volume level when the ambient brightness level is the outdoor brightness level.

As another example, the control part 340 may control the loss notification part 330 to output a loss notification light whose outdoor light intensity increases in proportion to the increase rate of the outdoor brightness level when the ambient brightness level is the outdoor brightness level.

As another example, the control part 340 can control the loss notification part 330 to output a loss notification light at a preset indoor light intensity regardless of the rate of increase in the indoor brightness level when the ambient brightness level is the indoor brightness level.

Next, the control part 340, when recognizing the movement of the wireless sound device, can measure the current loss notification output time of the loss notification part 330, check whether the current loss notification output time is the preset maximum output time, and if the current loss notification output time is less than the maximum output time, can recognize the movement of the wireless sound device from the sensing signal of the sensing part 310.

Here, the control part 340, if the current loss notification output time is the maximum output time or more, can check whether there is a device communicating with the communication part 320, and if there is a device communicating with the communication part, control the communication part 320 to transmit information on end of the loss situation of the wireless sound device 300 to the device, and if the information on end of the loss situation is transmitted, control the loss notification part 330 to stop outputting the loss notification.

At this time, the control part 340 can control the loss notification part 330 to stop outputting the loss notification if there is no device communicating with the communication.

In addition, the control part 340, if recognizing the movement of the wireless sound device 300, can check whether there is a device communicating with the communication part 320, if there is a device communicating with the communication part, control the communication part 320 to transmit information on end of the loss situation of the wireless sound device 300, and if the information on end of the loss situation is transmitted, control the loss notification part 330 to stop outputting the loss notification.

In addition, the control part 340, if determining that the wireless sound device 300 is lost, can control the communication part 320 to check whether there is a device that communicates with the communication part 320, and if there is a device that communicating with the communication part, control the communication part 320 to transmit information on the loss situation of the wireless sound device 300 to the device.

Next, the control part 340, when receiving information on a loss situation from a device that communicates with the communication part 320, can check the current wearing state of the wireless sound device 300, and if it is in a normal wearing state, control the loss notification part 330 to output a loss notification corresponding to the device, and when receiving information on end of a loss situation from a device that communicates with the communication part 320, control the loss notification part 330 to stop outputting the corresponding loss notification to the device.

Here, the control part 340, when checking the current wearing status of the wireless sound device, if the wireless sound device is not being worn, can calculate the falling distance of the wireless sound device from the sensing signal of the sensing part 310, determine whether the wireless sound device is lost based on the calculated falling distance, and, if the wireless sound device is lost, control the loss notification part 330 to output a loss notification, and, if movement of the wireless sound device is detected from the sensing signal of the sensing part 310 after the loss notification is output, control the loss notification part 330 to stop outputting the loss notification.

In addition, the control part 340, when checking the current wearing state of the wireless sound device, can check whether the wireless sound device 300 is normally worn on the user's ear or not, from the sensing signal of the sensing part 310 including the proximity sensor 314.

In this way, the apparatus for preventing loss of the wireless sound device of the present disclosure can prevent the loss of the wireless sound device by recognizing the falling of the wireless sound device and notifying the user of the loss of the wireless sound device.

In addition, the apparatus for preventing loss of the wireless sound device of the present disclosure can improve the usability of the wireless sound device for the user by minimizing loss situations with minimal power consumption by itself providing various loss notifications and adjusting the loss notifications in accordance with the surrounding environment by the wireless sound device.

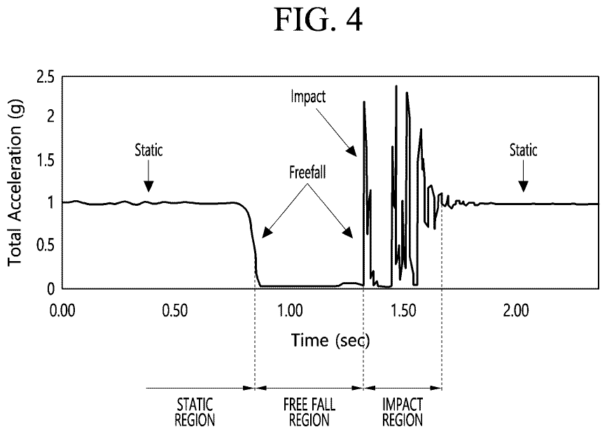

FIG. 4 is a view illustrating a method for calculating a falling distance of a wireless sound device according to one embodiment of the present disclosure.

As illustrated in FIG. 4, the present disclosure, when a sensing signal is received from an acceleration sensor, can identify a free fall region from a sensing signal, obtain a free fall time corresponding to the identified free fall region, and calculate a falling distance of a wireless sound device based on the obtained free fall time.

Here, the present disclosure can identify a free fall region based on a change rate of acceleration over time in a sensing signal.

In other words, the present disclosure can identify an impact region in which an acceleration value varies at a specific rate of change based on an acceleration change rate, identify a static region in which the acceleration value is constant among the regions prior to the identified impact region, and identify a free fall region in which the acceleration value remains a specific value or less between the identified static region and the impact region.

For example, the present disclosure can check whether there is a region that maintains an acceleration value of about 0.5 or less for a certain period of time between a static region and a collision region, and if there is a region that maintains an acceleration value of about 0.5 or less for a certain period of time, can identify the region as a free fall region.

In addition, the present disclosure, when the acceleration value changes at a specific change rate preset at a specific point in time when identifying the collision region, can recognize a specific point in time as the start point of the collision region.

For example, the present disclosure can recognize a specific point in time as a collision start point in time in a collision region when an acceleration value varies from a value about 0.5 or less to a value about 1.5 or more at a specific point in time.

In this way, the present disclosure can identify a region as a free fall region if, when the acceleration change rate changes from a static region in which a constant acceleration value is maintained for a first time period to a collision region in which the acceleration value is variable for a second time period, if there is a region between the static region and the collision region in which an acceleration value smaller than the acceleration value of the static region is maintained for a certain time period.

For example, the present disclosure can identify a region as a free fall region if there is a region in which an acceleration value of about 0.5 or less is maintained for a certain period of time between the static region and the impact region.

In addition, the present disclosure can obtain the free fall time from the time between the start time and the end time during the identified free fall region while maintaining an acceleration value of about 0.5 or less.

In addition, the present disclosure can calculate the falling distance by a formula consisting of h=½×g×t² (wherein, h is the falling distance, g is the gravitational acceleration of 9.81, and t is the free fall time).

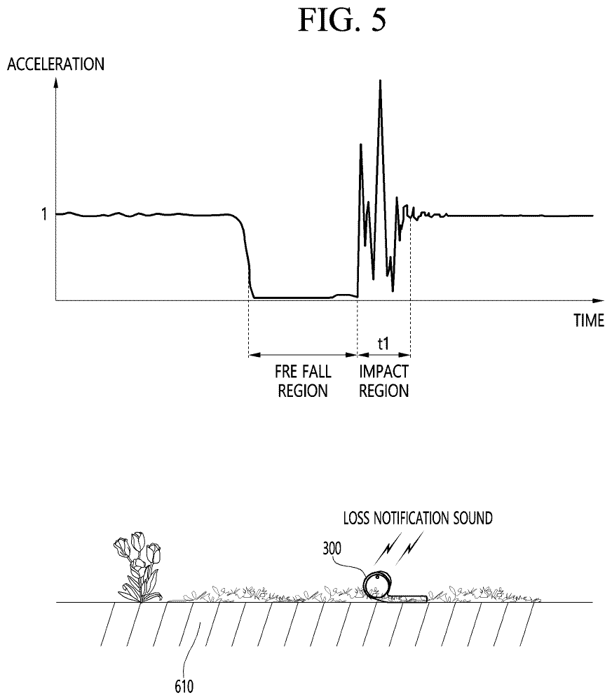

FIGS. 5 to 7 are views illustrating a method for predicting a collision environment of a wireless sound device according to an embodiment of the present disclosure.

As illustrated in FIGS. 5 to 7, the present disclosure can identify an impact region in which an acceleration value varies at a specific rate of change based on the acceleration change rate.

In other words, the present disclosure can recognize a specific point in time as the start point of a collision region if the acceleration value changes at a specific rate of change that is preset at a specific point in time.

For example, the present disclosure can recognize a specific point in time as a collision start point in a collision region if an acceleration value varies from a value about 0.5 or less to a value about 1.5 or more at a specific point in time.

Accordingly, the present disclosure can predict the collision environment of a wireless sound device based on the collision time from the collision start point in time of the collision region to the collision end point in time where the acceleration value is maintained constant.

As illustrated in FIG. 5, the present disclosure can predict that the collision environment of the wireless sound device 300 is a soft ground 610 if the collision time is within the first time t1.

The reason is that if the wireless sound device 300 falls on a soft ground 610 such as grass or carpet, the soft ground 610 cushions the falling impact of the wireless sound device 300, so the collision time is short and the collision region of the sensing signal appears narrow.

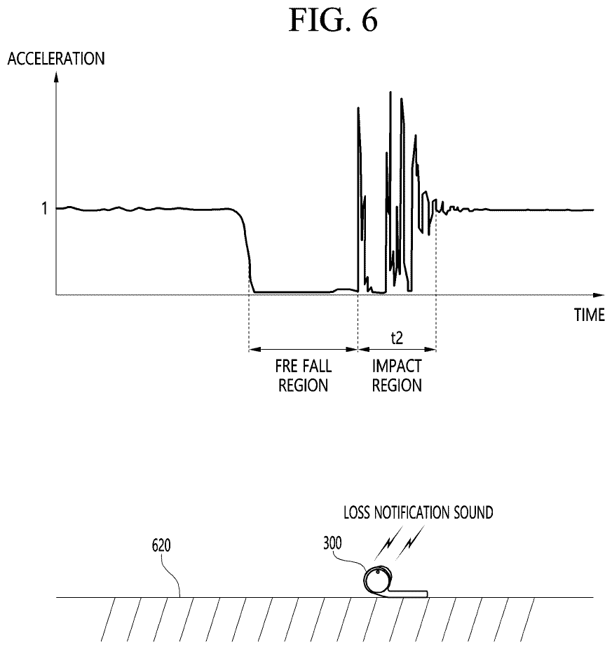

In addition, as illustrated in FIG. 6, the present disclosure can predict that the collision environment of the wireless sound device 300 is a solid ground 620 if the collision time is within a second time t2 that is longer than the first time t1.

The reason is that when the wireless sound device 300 falls on a hard ground 620 such as a floor or a road, the hard ground 620 increases the falling impact of the wireless sound device 300 more than the soft ground, so the impact time increases more than the impact time on the soft ground, and the impact region of the sensing signal also increases more than the impact time on the soft ground.

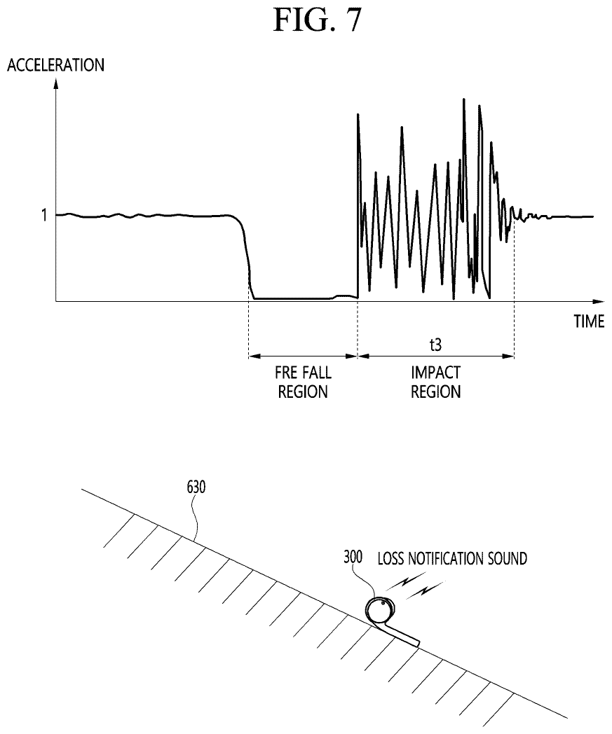

In addition, as illustrated in FIG. 7, the present disclosure can predict that the collision environment of the wireless sound device 300 is an inclined surface 630 if the collision time is within a third time t3 that is longer than the second time t2.

The reason is that if the wireless sound device 300 falls on an inclined ground 630 having a predetermined incline, the wireless sound device 300 rolls along the inclined ground 630, so that the impact of the fall is continuously applied, and thus the collision time becomes longer, and the collision region of the sensing signal also appears wider.

In addition, the present disclosure can predict the collision environment of a wireless sound device 300 by inputting an acceleration change rate corresponding to a collision time into a pre-learned neural network model, thereby outputting collision environment information.

Here, the neural network model can be pre-learned with the acceleration change rate corresponding to the collision time as input.

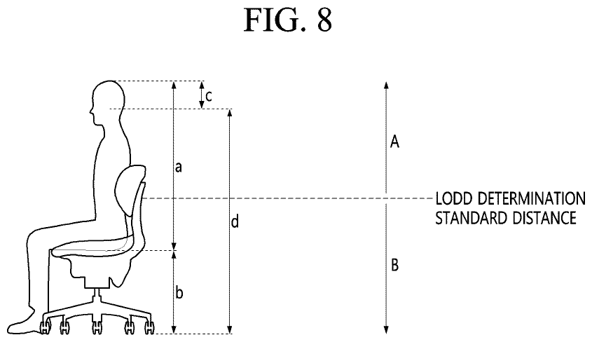

FIG. 8 is a view illustrating a method for determining loss of a wireless sound device according to an embodiment of the present disclosure.

As illustrated in FIG. 8, the present disclosure, when a falling distance is calculated, can check whether the calculated falling distance is a preset standard distance or more, and if the falling distance is the standard distance or more, can determine that the wireless sound device is lost.

Here, the present disclosure can set the standard distance based on the height of the user wearing the wireless sound device.

For example, the minimum standard distance can be set based on the user's sitting height.

For example, as illustrated in FIG. 8, if the user's height is about 160 cm, the user's sitting height a is about 800 mm, the chair height b is about 400 mm, and the height-eye height c is about 150 mm, the falling distance d of the wireless sound device worn on the ear when it falls to the ground can be about 1000 mm.

Here, if the loss determination standard distance of the wireless sound device is set to approximately 650 mm, region A, which is the standard distance of 650 mm or more, may be a region where there is a high possibility of losing the wireless sound device, and region B, which is the standard distance of 650 mm or less, may be a region where there is a high possibility of the user intentionally putting down the wireless sound device.

Therefore, the present disclosure can minimize false loss determination by setting the standard distance based on the height of the user wearing the wireless sound device.

In some cases, the present disclosure may check whether there is a user-defined value corresponding to a standard distance, and if there is the user-defined value, set the user-defined value as the standard distance, and if there is no user-defined value, set a default defined value set based on an average height of a user wearing a wireless sound device as the standard distance.

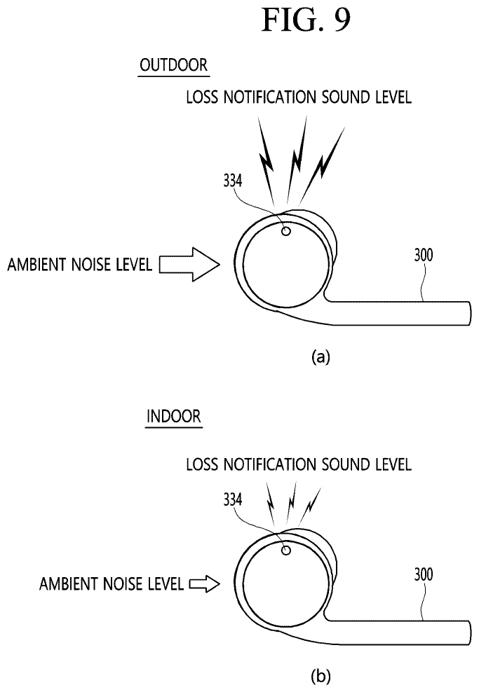

FIGS. 9 to 11 are views illustrating a method for notifying loss of a wireless sound device according to an embodiment of the present disclosure.

As illustrated in FIG. 9(a)(b), the present disclosure can calculate a noise level from ambient noise received by a microphone part when it is determined that a wireless sound device 300 is lost, and output a loss notification sound through a speaker 334 based on the noise level.

Here, the present disclosure can output a loss notification sound at an outdoor volume level when the noise level is an outdoor noise level, as in FIG. 9(a).

In addition, the present disclosure can output a loss notification sound at an indoor volume level that is lower than the outdoor volume level when the noise level is an indoor noise level, as illustrated in FIG. 9(b).

The reason is to output the optimal lost notification sound corresponding to the external environment while using the minimum power.

Additionally, the present disclosure may output a lost notification sound whose outdoor volume level increases in proportion to the rate of increase of the outdoor noise level when the noise level is an outdoor noise level.

In addition, the present disclosure can output a loss notification sound at a preset indoor volume level regardless of the rate of increase in the indoor noise level when the noise level is an indoor noise level.

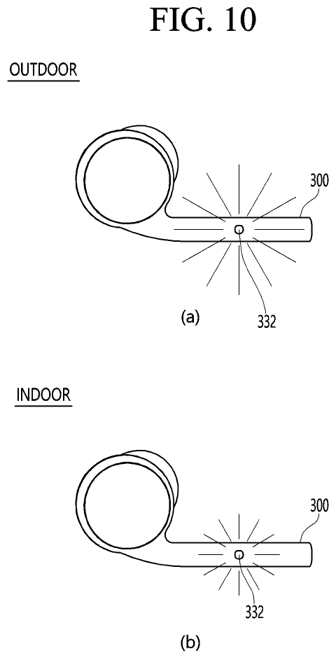

Next, as illustrated in FIG. 10(a)(b), when the wireless sound device 300 is determined to be lost, the present disclosure calculates the ambient brightness level from the sensing signal of the illumination sensor, and outputs a loss notification light through the light source part 332 based on the ambient brightness level.

Here, the present disclosure can output a loss notification light with outdoor light intensity when the ambient brightness level is an outdoor brightness level, as in FIG. 10(a).

In addition, the present disclosure can output a loss notification light with an indoor light intensity lower than an outdoor light intensity if the ambient light level is an indoor light level, as illustrated in FIG. 10(b).

The reason is to output the optimal lost notification light in accordance with the external environment while using the minimum power.

In addition, the present disclosure can output a lost notification light whose outdoor light intensity increases in proportion to the rate of increase of the outdoor brightness level when the ambient brightness level is the outdoor brightness level.

In addition, the present disclosure can output a loss notification light with a preset indoor light intensity regardless of the rate of increase of the indoor brightness level when the ambient brightness level is the indoor brightness level.

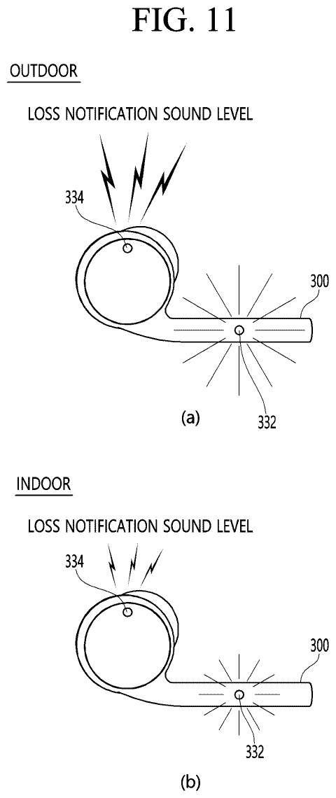

Next, as illustrated in FIG. 11(a) (b), the present disclosure, if the wireless sound device 300 is determined to be lost, can calculate a noise level from ambient noise received by the microphone part, calculate an ambient brightness level from a sensing signal of a illumination sensor, and output a loss notification sound through the speaker 334 based on the noise level, while output a loss notification light through the light source part 332 based on the ambient brightness level.

Here, the present disclosure can output a loss notification sound at an outdoor volume level if the noise level is an outdoor noise level, as illustrated in FIG. 11(a), and can output a loss notification light at an outdoor light intensity when the ambient brightness level is an outdoor brightness level.

In addition, the present disclosure, as illustrated in FIG. 11(b), can output a loss notification sound at an indoor volume level lower than an outdoor volume level if the noise level is an indoor noise level, and can output a loss notification light at an indoor light intensity lower than an outdoor light intensity if the ambient brightness level is an indoor brightness level.

The reason is to output the optimal lost notification sound and lost notification light in accordance with the external environment while using the minimum power.

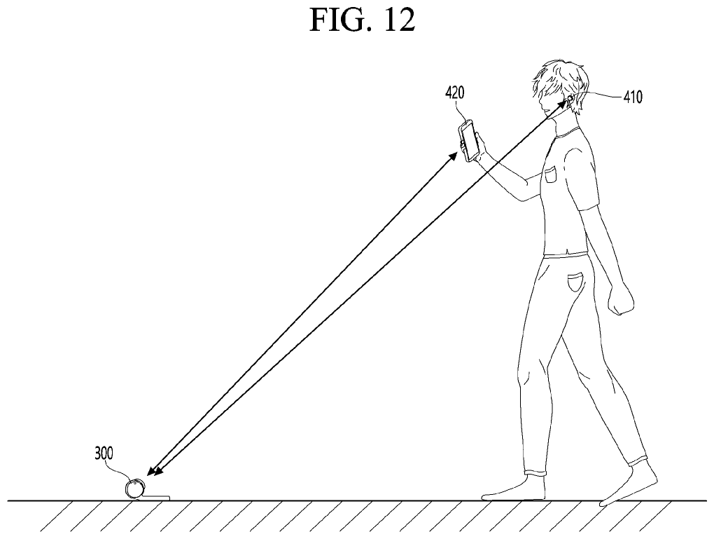

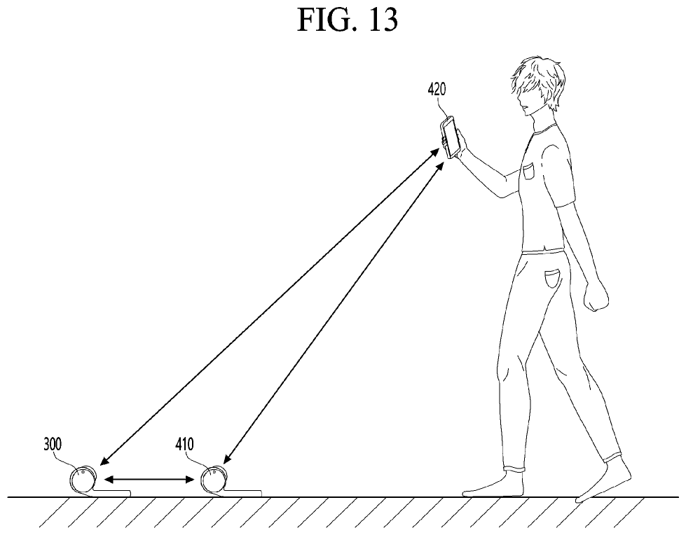

FIGS. 12 and 13 are views illustrating a method for transmitting information on loss situation of a wireless sound device to a peripheral device according to an embodiment of the present disclosure.

As illustrated in FIG. 12, the present disclosure, if the wireless sound device 300 is determined to be lost, can check whether there are devices, including other wireless sound devices 410 and terminals 420 that communicate with the communication network, in the vicinity, and if there are devices which are connected to the communication, transmit information on the loss situation of the wireless sound device 300 to the devices.

In other words, the present disclosure, if a wireless sound device 300 is determined to be lost, can identify a device that communicates with the wireless sound device 300, and if the identified device is another wireless sound device 410 and a terminal 420, transmit information on the loss situation of the wireless sound device 300 to the other wireless sound device 410 and terminal 420 that are connected to the communication.

In addition, the present disclosure can measure the current loss notification output time of the wireless sound device 300, check whether the current loss notification output time is a preset maximum output time, and recognize the movement of the wireless sound device 300 if the current loss notification output time is less than the maximum output time.

Next, the present disclosure, if recognizing movement of a wireless sound device 300, can check whether there is a device which is connected to communication, if there is a device which is connected to communication, transmit information on the end of a loss situation of the wireless sound device 300 to the device, and if the information on the end of a loss situation is transmitted, stop outputting of a loss notification of the wireless sound device 300.

Next, the present disclosure can measure the current loss notification output time of the wireless sound device 300, if the current loss notification output time is the maximum output time or more, check whether there is a device connected which is connected to communication, if there is a device which is connected to communication, transmit information on the end of the loss situation of the wireless sound device 300 to the device, and if the information on the end of the loss situation is transmitted, stop outputting of a loss notification of the wireless sound device 300.

In addition, the present disclosure, if built into another wireless sound device 410, if receiving the information on the loss situation from a lost wireless sound device 300, can check the current wearing state of the other wireless sound device 410, if it is in a normal wearing state, output a loss notification corresponding to the lost wireless sound device 300, and if receiving information on the end of a loss situation from the lost wireless sound device 300, stop outputting the loss notification corresponding to the lost wireless sound device 300.

Here, the present disclosure can determine whether the other wireless sound device 410 is lost based on the falling distance when checking the current wearing status of the other wireless sound device 410 if the other wireless sound device 410 is not worn.

As illustrated in FIG. 13, the present disclosure outputs a loss notification if both a wireless sound device 300 and another wireless sound device 410 are determined to be lost, and transmits information on loss notification situation to a terminal 420 carried by the user, thereby allowing the user to recognize the loss of the wireless sound device.

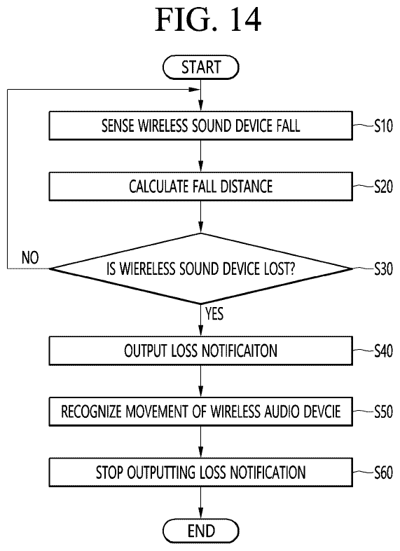

FIGS. 14 to 17 are flowcharts illustrating a method for preventing loss of a wireless sound device according to an embodiment of the present disclosure.

As illustrated in FIG. 14, the present disclosure can sense the falling of a wireless sound device (S10).

Next, the present disclosure can calculate the falling distance of a wireless sound device (S20).

Here, the present disclosure can identify a free fall region from a sensing signal that senses the fall of a wireless sound device, obtain a free fall time corresponding to the identified free fall region, and calculate a fall distance of the wireless sound device based on the obtained free fall time.

Next, the present disclosure can determine whether a wireless sound device is lost based on the calculated falling distance (S30).

In addition, the present disclosure can output a loss notification if the wireless sound device is lost (S40).

Here, the present disclosure, if the wireless sound device is determined to be lost, can check whether there is a device that communicates with the wireless sound device, and if there is the device that is connected to the wireless sound device, information on the loss situation of the wireless sound device can be transmitted to the device.

In addition, the present disclosure can calculate a noise level from ambient noise received by a wireless sound device and output a loss notification sound based on the noise level.

In some cases, the present disclosure may calculate a brightness level from the ambient brightness received by the wireless sound device and output a lost notification light based on the brightness level.

Next, the present disclosure can recognize the movement of a wireless sound device (S50).

Next, the present disclosure, if movement of a wireless sound device is recognized, can stop outputting a loss notification (S60).

Here, the present disclosure if recognizing movement of a wireless sound device, can check whether there is a device to be connected to communication, and if there is a device to be connected to communication, transmit information on the end of a loss situation of the wireless sound device to the device, and if the information on the end of a loss situation is transmitted, stop outputting a loss notification.

Step S40 of FIG. 14 is described in more detail as follows.

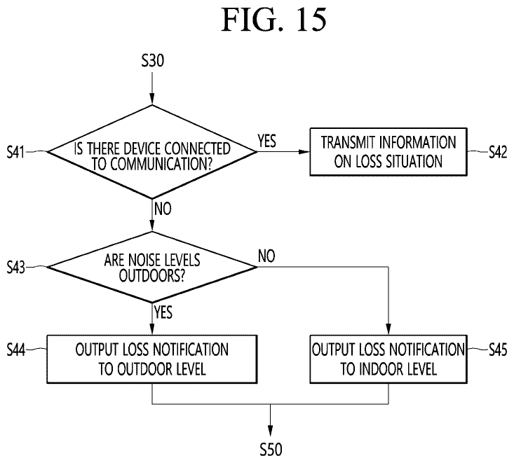

As illustrated in FIG. 15, the present disclosure, when it is determined that a wireless sound device is lost, can check whether there is a device which is connected to communication (S41).

Next, the present disclosure, if there is a device that is connected to communication, can transmit the information on the loss situation to a device (S42).

In addition, the present disclosure can calculate a noise level from ambient noise received by a microphone if there is no device connected to a communication, and determine whether the noise level is an outdoor noise level based on the noise level (S43).

Next, the present disclosure can output a loss notification sound at an outdoor volume level if the noise level is an outdoor noise level (S44).

Here, the present disclosure may output a lost notification sound whose outdoor volume level increases in proportion to the rate of increase in the outdoor noise level.

In addition, the present disclosure can output a loss notification sound at an indoor volume level that is lower than an outdoor volume level if the noise level is an indoor noise level (S45).

Here, the present disclosure can output a loss notification sound at a preset indoor volume level regardless of the rate of increase in indoor noise level.

Step S50 of FIG. 14 is described in more detail as follows.

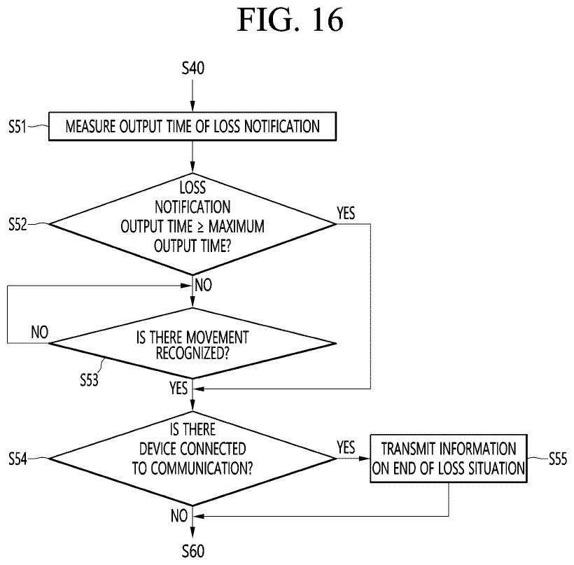

As illustrated in FIG. 16, the present disclosure, if a lost notification is output, can measure the current lost notification output time (S51).

Next, the present disclosure can check whether the current lost notification output time is the preset maximum output time (S52).

Next, the present disclosure can recognize the movement of the wireless sound device from the sensing signal if the current lost notification output time is less than the maximum output time (S53).

In addition, the present disclosure can check whether there is a device which is connected to communication if the current lost notification output time is the maximum output time or more (S54).

In addition, the present disclosure can transmit information on end of loss situation of a wireless sound device to a device if there is a device which is connected to the communication (S55).

In addition, the present disclosure, if recognizing the movement of the wireless sound device, can check whether there is a device which is connected to the communication (S54), and if there is a device which is connected to the communication, transmit information on end of loss situation of the wireless sound device to the device (S55).

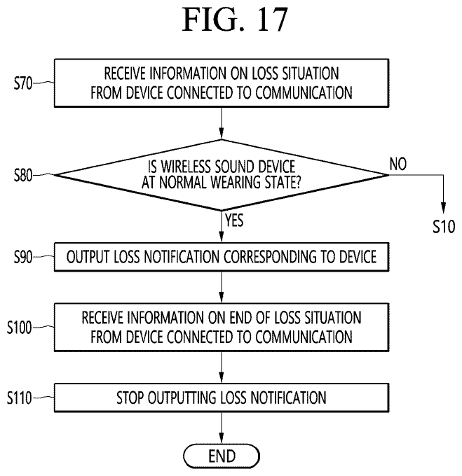

As illustrated in FIG. 17, the present disclosure can receive information on loss situation from a device which is connected to a communication (S70).

In addition, the present disclosure can check the current wearing status of a wireless sound device (S80).

Next, the present disclosure can output a loss notification corresponding to the device if in a normal wearing state (S90).

Next, the present disclosure can receive information on end of a lost situation from a device which is connected to a communication (S100).

In addition, the present disclosure can stop outputting a loss notification corresponding to the device (S110).

In addition, the present disclosure, when checking the current wearing status of a wireless sound device, if the wireless sound device is not being worn, can calculate the fall distance of the wireless sound device, determine whether the wireless sound device is lost based on the calculated fall distance, if the wireless sound device is lost, output a loss notification, and if recognizing movement of the wireless sound device, stop outputting the loss notification.

In this way, the apparatus for preventing loss of the wireless sound device of the present disclosure can prevent the loss of the wireless sound device by recognizing the falling of the wireless sound device and notifying the user of the loss of the wireless sound device.

In addition, the apparatus for preventing loss of the wireless sound device of the present disclosure can improve the usability of the wireless sound device for the user by minimizing loss situations with minimal power consumption by providing various loss notifications and adjusting the loss notifications in accordance with the surrounding environment by the wireless sound device itself.

### INDUSTRIAL APPLICABILITY

According to the apparatus for preventing loss of wireless sound device according to the present disclosure, the apparatus for preventing loss of wireless sound device has the effect of preventing the loss of a wireless sound device by recognizing the falling of the wireless sound device and notifying the user of the loss of the wireless sound device, and therefore has remarkable industrial applicability.

1. An apparatus for preventing loss of wireless sound device comprising:
a sensing part sensing the fall of a wireless sound device;
a communication part communicating with at least one device;
a loss notification part outputting a loss notification of the wireless sound device; and
a control part controlling the communication part and the loss notification part,
wherein the control part calculates the falling distance of the wireless sound device from the sensing signal of the sensing part, determines whether the wireless sound device is lost based on the calculated falling distance, if the wireless sound device is lost, controls the loss notification part to output the loss notification, and if movement of the wireless sound device is recognized from the sensing signal of the sensing part after the output of the loss notification, controls the loss notification part to stop outputting the loss notification.

2. The apparatus for preventing loss of wireless sound device of claim 1,
wherein the sensing part includes an acceleration sensor sensing changes in acceleration due to gravity.

3. The apparatus for preventing loss of wireless sound device of claim 1,
wherein the control part, when calculating the falling distance, if a sensing signal is received from the sensing part, identifies a free fall region from the sensing signal, obtains a free fall time corresponding to the identified free fall region, and calculates the falling distance of the wireless sound device based on the obtained free fall time.

4. The apparatus for preventing loss of wireless sound device of claim 3,
wherein the control part, when identifying the free fall region, identifies the free fall region based on the acceleration change rate over time in the sensing signal.

5. The apparatus for preventing loss of wireless sound device of claim 4,
wherein the control part identifies an impact region in which an acceleration value varies at a specific rate of change based on the acceleration change rate, identifies a static region in which the acceleration value is constant among the regions prior to the identified impact region, and identifies a free fall region in which the acceleration value remains a specific value or less between the identified static region and the impact region.

6. The apparatus for preventing loss of wireless sound device of claim 4,
wherein the control part, when the acceleration change rate changes from a static region in which a constant acceleration value is maintained for a first time period to a collision region in which the acceleration value is variable for a second time period, if there is a region between the static region and the collision region in which an acceleration value smaller than the acceleration value of the static region is maintained for a certain time period, identifies the region as the free fall region.

7. The apparatus for preventing loss of wireless sound device of claim 3,
wherein the control part, when calculating the falling distance, calculates the falling distance by a formula consisting of h=½×g×t² (wherein, h is the falling distance, g is the gravitational acceleration of 9.81, and t is the free fall time).

8. The apparatus for preventing loss of wireless sound device of claim 1,
wherein the control part, when determining whether the wireless sound device is lost, if the falling distance is calculated, checks whether the calculated falling distance is a preset standard distance or more, and if the falling distance is the standard distance or more, determines the wireless sound device to be lost.

9. The apparatus for preventing loss of wireless sound device of claim 1, further comprising:
a microphone part receiving ambient noise,
wherein the control part, if the wireless sound device is determined to be lost, calculates a noise level from ambient noise received by the microphone part, and controls the loss notification part to output a loss notification sound based on the noise level.

10. The apparatus for preventing loss of wireless sound device of claim 1,
wherein the control part, when the movement of the wireless sound device is recognized, measures the current loss notification output time of the loss notification part, and confirms whether the current loss notification output time is a preset maximum output time, and if the current loss notification output time is less than the maximum output time, recognizes the movement of the wireless sound device from the sensing signal of the sensing part.

11. The apparatus for preventing loss of wireless sound device of claim 10,
wheire the control part, if the current loss notification output time is the maximum output time or more, checks whether there is a device communicating with the communication part, and if there is the device communicating with the communication part, controls the communication part to transmit information on the end of the loss situation of the wireless sound device to the device, and if the information on the end of the loss situation is transmitted, controls the loss notification part to stop outputting the loss notification.

12. The apparatus for preventing loss of wireless sound device of claim 10,
wherein the control part, if the movement of the wireless sound device is recognized, checks whether there is a device communicating with the communication part, and if there is the device communicating with the communication part, controls the communication part to transmit information on end of a loss situation of the wireless sound device to the device, and if the information on end of a loss situation is transmitted, controls the loss notification part to stop outputting the loss notification.

13. The apparatus for preventing loss of wireless sound device of claim 1,
wherein the control part, if the wireless sound device is determined to be lost, checks whether there is a device communicating with the communication part, and if there is a device communicating with the communication part, controls the communication part to transmit information on the loss situation of the wireless sound device to the device.

14. The apparatus for preventing loss of wireless sound device of claim 1,
wherein the control part, if receiving information on the loss situation from a device communicating with the communication part, checks the current wearing status of the wireless sound device, and if it is in a normal wearing status, controls the loss notification part to output the corresponding loss notification to the device, if information on end of a loss situation is received from a device that is communicating with the communication part, controls the loss notification part to stop outputting the corresponding loss notification to the device.

15. A method for preventing loss of a wireless sound device, comprising:
sensing the falling of the wireless sound device;
calculating the falling distance of the wireless sound device;
determining whether the wireless sound device is lost based on the calculated falling distance;
outputting a loss notification if the wireless sound device is lost;
recognizing the movement of the wireless sound device; and
stopping output of the loss notification if movement of the wireless sound device is recognized.
